(19) United States
(12) Patent Application Publication
(10) Pub. No.: US 2006/0083910 A1
(43) Pub. Date: Apr. 20, 2006

(54) Method for the production of acetylated wood

(76) Inventors: Otmar Hoglinger, Osterreich (AT); Manfred Ratzsch, Osterreich (AT); Hartmut Bucka, Osterreich (AT); Iidiko Tanczos, Osterreich (AT); Stefan Stallinger, Osterreich (AT); Harald Schmidt, Osterreich (AT)

Correspondence Address: THE WEBB LAW FIRM, P.C., 700 KOPPERS BUILDING, 436 SEVENTH AVENUE, PITTSBURGH, PA, 15219, US

(21) Appl. No.: 10/536,281

(22) PCT Filed: Nov. 27, 2003
(86) PCT No.: PCT/EP03/13330

§ 371 Date: May 25, 2005

(30) Foreign Application Priority Data
Nov. 28, 2002 (AT) AT 1783/2002

(51) Int. Cl. C08B 3/16; B32B 21/02

(52) U.S. Cl. 428/292.4; 536/63; 536/64

(57) ABSTRACT

Disclosed is acetylated wood which has an acetyl group content of 3 to 30 percent by weight and can be produced by reacting wood products with isopropenyl acetate at temperatures of 50 to 125° C. in the present of 0.02 to 2 percent by weight of acid catalyst, the percentage being in relation to the used isopropenyl acetate. The reaction with isopropenyl acetate can take place in a liquid phase or gas phase. The acetylated wood produced according to said method is suitable for wood products requiring high dimensional stability and extended natural durability.

The invention relates to a process for producing acetylated wood having an acetyl group content of from 3 to 30% by mass, based on dry wood.

The production of acetylated wood by reaction of wood with acetic anhydride at temperatures of from 100 to 130° C. is known (GB963929A1; U.S. Pat. No. 5,525,721A; U.S. Pat. No. 5,431,868A). Disadvantages in the acetylation of wood by means of acetic anhydride are the loss of the natural gloss and discoloration of the wood (U.S. Pat. No. 3,094,431A) and the acetic acid which is formed as by-product and has to be removed from the wood by means of a complicated extraction, with small remaining amounts leading to odor pollution and to degradation of the cellulose component of the wood.

Also known is the acetylation of wood by means of ketene, in which no troublesome amounts of acetic acid are formed as by-product (Rowell, R., “The Chemistry of Solid Wood”, Advances in Chemistry Series, Vol. 207, p. 175). However, the long reaction times and low acetylation yields are disadvantages of this process.

The acetylation of wood using acetyl chloride is likewise known. Here, the low yields and the hydrochloric acid formed as by-product are the disadvantages of the process (Rowell, R., “The Chemistry of Solid Wood”, Advances in Chemistry Series, Vol. 207, p. 175).

It is an object of the invention to provide a process for acetylating wood which avoids the disadvantages of the prior art.

The object of the invention was achieved by a process for producing acetylated wood having an acetyl group content of from 3 to 30% by mass, based on dry wood, in which wood products having a residual moisture content of from 2 to 15% by mass are, according to the invention, reacted at reaction temperatures of from 50 to 125° C. and residence times of from 0.2 to 6 hours with isopropenyl acetate in the presence of from 0.02 to 2% by mass, based on the isopropenyl acetate used, of acid catalysts, and are dried at temperatures of from 80 to 125° C./0.1 to 1 bar at residence times of from 0.2 to 8 hours, with the reaction with isopropenyl acetate being able to be carried out in the liquid phase or in the gas phase.

The wood products used in the process of the invention are preferably solid wood products produced by material-removing machining, in particular in the form of veneers, boards, planks, squared timber, beams or profiles, wood particles, especially in the form of wood flour, wood fibers or wood shavings, or wooden end products.

The wood products can consist of broad-leaved or coniferous timbers. When wood particles are used, the wood scrap in the form of wood flour, wood fibers and wood shavings obtained in wood processing can be used. It is likewise possible to use mixtures of wood scrap.

It is advantageous to use wood products having a residual moisture content of less than 12% by mass in the acetylation; a residual moisture content in the range from 5 to 12% by mass is favorable. Low residual moisture contents delay transport of reactants into the wood.

Examples of acid catalysts which can be used in the process of the invention are acids such as hydrochloric acid, sulfuric acid, phosphoric acid, boric acid, chlorosulfonic acid, p-toluenesulfonic acid or hydrogen chloride, and also acid formers such as carboxylic anhydrides, carboxylic acid chlorides, chlorosilanes, phosphorus pentoxide or sulfur dioxide, in the case of which acid formation occurs in the presence of water.

In order to keep the amount of water introduced into the reaction system as low as possible in the case of a reaction in the liquid phase, it is advantageous to use the catalytic amounts of acids in high concentration. Concentrated sulfuric acid as catalyst has the advantage of introducing a little water into the reaction system, but the disadvantage of discoloring the wood due to its oxidizing action.

Preferred acids as acid catalysts are hydrogen chloride, phosphoric acid, boric acid, chlorosulfonic acid and/or p-toluenesulfonic acid.

Preferred acid formers as acid catalysts are compounds such as carboxylic anhydrides, particularly preferably maleic anhydride, acetic anhydride, phthalic anhydride and/or pyromellitic dianhydride, carboxylic acid chlorides, particularly preferably benzoyl chloride, acryloyl chloride and/or acetyl chloride, and/or chlorosilanes.

Examples of suitable chlorosilanes are trichlorosilane, silicon tetrachloride, dimethylhydrogenchlorosilane or methylhydrogendichlorosilane.

Preference is given to reacting with isopropenyl acetate in the liquid phase at a mass ratio of isopropenyl acetate/wood of from 0.5:1 to 15:1 and a reaction temperature of from 45 to 95° C.

Preferred reaction conditions in the reaction of wood with isopropenyl acetate in the liquid phase are reaction temperatures of from 85 to 95° C., residence times of from 1.5 to 3 hours, and the use of from 0.1 to 0.3 mol of concentrated hydrochloric acid as catalyst per liter of isopropenyl acetate used, with the acetone formed being distilled off during the reaction.

An increase in the use of a catalytic amount of concentrated hydrochloric acid from 0.3 mol/l to 0.5 mol/l of isopropenyl acetate used leads, owing to the higher amount of water introduced, only to an insignificant increase in the reaction rate. Catalytic amounts of concentrated hydrochloric acid below 0.05 mol/l of isopropenyl acetate used display only a very low catalytic activity.

Stirred reactors are suitable for the acetylation of wood particles in the form of wood flour, wood fibers or wood shavings with isopropenyl acetate in the liquid phase. It is in this case advantageous for the acetone formed in the reaction to be distilled off continuously from the stirred reactor in order to achieve high yields. The work-up of the reaction mixture can be carried out by separating off the partially acetylated wood particles in filter presses or peeler centrifuges, if appropriate slurrying the wood particles in water or water/acetone mixtures and filtering them off, and subsequently drying the wood particles in belt, drum or atomization drying units at from 100 to 125° C.

The acetylation of solid wood products or final wooden articles with isopropenyl acetate in the liquid phase can be carried out in trough reactors, reactors having a tumbling action or rotating vessels, and in this case, too, it is advantageous for the acetone formed to be distilled off continuously. Drying of the partially acetylated solid wood products or final wooden articles can be carried out in vacuum drying units or drying tunnels at from 80 to 125° C.

The isopropenyl acetate which has not been reacted in the reaction in the liquid phase can, after fractionation to remove acetone, water and acetic acid impurities, be returned to the process.

A further preferred variant of the process of the invention comprises the reaction of wood products with isopropenyl acetate in the gas phase at reaction temperatures of from 100 to 120° C. and residence times of from 0.3 to 3 hours under atmospheric pressure using gaseous isopropenyl acetate and hydrogen chloride gas. This variant is particularly useful for the acetylation of wood shavings, wood fibers and wood flour, since the acetylation can be carried out in fluidized-bed reactors or screw conveyors with continuous discharge of the acetylated wood particles. After condensation of the gas mixture and fractionation, isopropenyl acetate can be returned to the process.

As a process variant, the reaction of wood products with isopropenyl acetate in autoclaves at reaction temperatures of from 90 to 120° C. and residence times of from 0.2 to 2 hours at from 1.1 to 35 bar using anhydrous hydrogen chloride as catalyst is likewise preferred. Suitable reactors are rotating pressure vessels or autoclaves having a tumbling action. The advantage of pressurization with inert gases such as nitrogen or argon is acceleration of the diffusion of isopropenyl acetate and hydrogen chloride into the compact solid wood products during the acetylation.

Both in the reaction in the gas phase and the reaction in autoclaves, the advantage of the anhydrous hydrogen chloride used as catalyst is that introduction of water into the reaction system is avoided and hydrolysis of small proportions of the isopropenyl acetate is prevented.

The acetylated wood produced by the process of the invention is preferably used for wood products having high requirements in terms of dimensional stability and natural durability, in particular for exterior doors, facade boarding, wainscoting and high-humidity room applications.

Fiberboards produced from acetylated wood shavings have an improved strength and natural durability compared to customary fiberboards.

The invention is illustrated by the following examples:

Titrimetric Determination of the Degree of Acetylation

About 0.5 g of dried acetylated wood flour are weighed out to a precision of 0.1 mg and transferred to a 250 ml conical flask. After addition of 10 ml of 75% ethanol, the mixture is heated at 50° C. for 35 minutes. 25 ml of 0.5 mol/l aqueous sodium hydroxide solution are then pipetted in and the mixture is once again heated at 50° C. for 30 minutes. After addition of 25 ml of 0.5 mol/l hydrochloric acid solution, the mixture is backtitrated with 0.5 mol/l aqueous sodium hydroxide solution against phenolphthalein. The ester groups are completely hydrolyzed by the sodium hydroxide and the base itself is consumed. The consumption gives the number of acetyl groups per g of wood flour. For standardization, a blank value is determined using untreated wood flour and is employed in the calculation:

$$B = \frac{\frac{N \cdot a}{1000} - BV \cdot W}{W}$$

B molar amount of acetyl groups in the sample (mol/g)

N concentration of the aqueous sodium hydroxide solution (mol/l)

a titration volume (ml)

W weight (g)

BV blank value

Gravimetric Determination of the Degree of Acetylation

Wood shavings or solid wood test specimens are extracted with acetone in a Soxhlet apparatus for 4 hours and are dried at 105° C. in a vacuum drying oven for 3 days. The weight increase is corrected by a blank value which is obtained from the extraction of untreated wood with acetone and isopropenyl acetate. The increase in weight is divided by the weight of dry untreated wood.

### EXAMPLES 1-13

### Acetylation of Wood Powder with Isopropenyl Acetate in the Liquid Phase Using Hydrochloric Acid as Catalyst

289 g of wood flour (residual moisture content: 7% by mass, mean particle diameter: 100 μm, composition: 90% by mass of spruce and 10% by mass of fir, pH=5.5 at 100 g/l in H₂O and 20° C.) and 3554 g of isopropenyl acetate (d²⁰=0.920 g/cm³, b.p. 95-97° C.) containing from 0.16 to 0.32 mol of concentrated hydrochloric acid (31.5%)/l of isopropenyl acetate are introduced into a 5 l stirred reactor heated by means of an oil bath and provided with a descending condenser and condensate receiver, heated to the reaction temperature, maintained at the reaction temperature for from 0.5 to 6 hours while continuously distilling off the acetone formed, the mixture is cooled and filtered, the acetylated wood powder is dispersed in 3 l of an acetone/water mixture, filtered off and dried at 105° C. in a vacuum drying oven for 6 hours. Reaction conditions and degree of acetylation are summarized in table 1.

### EXAMPLE 14

### Acetylation of Wood Powder with Isopropenyl Acetate in the Liquid Phase Using Maleic Anhydride as Catalyst

289 g of wood flour (residual moisture content: 7% by mass, mean particle diameter: 100 μm, composition: 90% by mass of spruce and 10% by mass of fir, pH=5.5 at 100 g/l in H₂O and 20° C.) and 3554 g of isopropenyl acetate (d²⁰=0.920 g/cm³, b.p. 95-97° C.) containing 0.4 mol of maleic anhydride/l of isopropenyl acetate in solution are introduced into a 5 l stirred reactor heated by means of an oil bath and provided with a descending condenser and condensate receiver, heated to 90° C., maintained at 90° C. for 5 hours while continuously distilling off the acetone formed, the mixture is cooled and filtered, the acetylated wood powder is dispersed in 3.5 l of acetone/water mixture, filtered off and dried at 105° C. in a vacuum drying oven for 6.5 hours. The increase in weight produced by acetylation is 14.9% by mass.

### EXAMPLE 15

### Acetylation of Wood Shavings with Isopropenyl Acetate in the Liquid Phase

94 g of wood shavings (shavings of spruce wood, average dimensions: 1×2×0.05 cm) and 3554 g of isopropenyl acetate (d²⁰=0.920 g/cm³, b.p. 95-97° C.) containing 0.31 mol of concentrated hydrochloric acid (31.5%)/l of isopropenyl acetate are introduced into a 5 l stirred reactor heated by means of an oil bath and provided with a descending condenser and condensate receiver, heated to 85° C., maintained at the reaction temperature for 3 hours while continuously distilling off the acetone formed, the mixture is cooled and filtered, the acetylated wood shavings are dispersed in 3 l of an acetone/water mixture, filtered off and dried at 105° C. in a vacuum drying oven for 6 hours. The increase in weight resulting from acetylation is 16.5% by mass.

### EXAMPLES 16-19

### Acetylation of Solid Wood with Isopropenyl Acetate in the Liquid Phase Using Hydrochloric Acid as Catalyst

295 g of spruce wood test specimens (halved wood cubes, dimensions: 2×2×1 cm, residual moisture content: 10% by mass) and 3540 g of isopropenyl acetate (d²⁰=0.920 g/cm³, b.p. 95-97° C.) containing 0.32 mol of concentrated hydrochloric acid (31.5%)/l of isopropenyl acetate are introduced into a 5 l stirred reactor heated by means of an oil bath and provided with a descending condenser and condensate receiver, heated to the reaction temperature, maintained at the reaction temperature for from 1 to 6 hours while continuously distilling off the acetone formed, the acetylated wood test specimens are filtered off and washed with 3 l of an acetone/water mixture and dried at 115° C. in a vacuum drying oven for 6 hours. Reaction conditions and degree of acetylation are summarized in table 2.

### EXAMPLE 20

### Acetylation of Solid Wood with Isopropenyl Acetate in the Liquid Phase Using p-toluenesulfonic Acid as Catalyst

280 g of spruce wood test specimens (halved wood cubes, dimensions: 2×2×1 cm, residual moisture content: 10% by mass) and 3540 g of isopropenyl acetate (d²⁰=0.920 g/cm³, b.p. 95-97° C.) containing 0.22 mol of p-toluenesulfonic acid/l of isopropenyl acetate are introduced into a 5 l stirred reactor heated by means of an oil bath and provided with a descending condenser and condensate receiver, heated to 90° C., maintained at the reaction temperature for 5 hours while continuously distilling off the acetone formed, the acetylated wood test specimens are filtered off and washed with 3.2 l of an acetone/water mixture and dried at 110° C. in a vacuum drying oven for 8 hours.

The increase in weight resulting from acetylation is 21.9% by mass.

### EXAMPLE 21

### Acetylation of Wood Powder in a Screw Conveyor

Wood flour (residual moisture content: 7% by mass, mean particle diameter: 100 μm, composition: 90% by mass of spruce and 10% by mass of fir, pH=5.5 at 100 g/l in H₂O and 20° C.) is introduced at a rate of 0.25 kg/h into a stainless steel screw conveyor (Ø=20 mm, 1=1450 mm) heated electrically to 115° C. and provided with metering belt balance, gas inlet port and buffer vessel with star feeder and gaseous isopropenyl acetate which has been preheated to 110° C. and contains 0.15 mol of hydrogen chloride/kg of isopropenyl acetate is introduced at a rate of 120l /hour via the gas inlet port. The acetylated wood powder is discharged from the buffer vessel via a star feeder and dried at 115° C. on a belt dryer. After leaving the buffer vessel, the gas mixture is conveyed through a condenser, and isopropenyl acetate is separated off from the condensate by fractional distillation and returned to the process.

The increase in weight of the wood flour as a result of acetylation is 11.5% by mass.

### EXAMPLE 22

### Acetylation of Wood Shavings in a Stirring Autoclave

120 g of wood shavings (shavings of spruce wood, average dimensions: 1×2×0.05 cm) are introduced into a 5 l stirring autoclave heated by means of an oil bath and provided with a descending condenser and condensate receiver. After closing the autoclave, 3200 g of isopropenyl acetate (d²⁰=0.920 g/cm³, b.p. 95-97° C.) containing 0.28 mol of hydrogen chloride/l of isopropenyl acetate are introduced into the autoclave via a pressure metering vessel, the mixture is heated to 120° C. and maintained at the reaction temperature for 1.5 hours while continuously distilling off the resulting acetone under pressure. After cooling to 90° C., the autoclave is vented, the mixture is filtered after cooling, the acetylated wood shavings are dispersed in 3 l of an acetone/water mixture, filtered off and dried at 115° C. in a vacuum drying oven for 6 hours.

The increase in weight resulting from acetylation is 17.5% by mass.

### EXAMPLE 23

### Continuous Acetylation of Spruce Wood Veneer with Isopropenyl Acetate in the Liquid Phase Using Hydrochloric Acid as Catalyst

In a heatable closed coated impregnation trough which has a volume of 1800 l and is provided with a circulation facility for liquid media, 8 pairs of deflection rollers and 2 pairs of rollers for the intake and output of sheet stock and is filled with 1350 l of isopropenyl acetate (d²⁰=0.920 g/cm³, b.p. 95-97° C.) containing 0.30 mol of concentrated hydrochloric acid (31.5%)/l of isopropenyl acetate, a spruce wood veneer strip (width: 600 mm, thickness: 2 mm) is acetylated continuously at a bath temperature of 90° C. and a mean residence time of 20 minutes and after leaving the impregnation trough is dried at 110° C. by treatment with hot air in a heating tunnel.

The increase in weight of a test strip which has been extracted with acetone in a Soxhlet apparatus for 4 hours and dried at 105° C. in a vacuum drying oven for 3 days is 12.2% by mass.

### EXAMPLE 24

### Acetylation of Boards in a Tumbling Autoclave

200 kg of beechwood boards (length: 2 m, width: 120 mm, thickness: 25 mm, residual moisture content: 8% by mass) are introduced into a cylindrical tumbling autoclave (h=2.5 m, Ø=0.8 m). After closing the tumbling autoclave, 750 l of isopropenyl acetate (d²⁰=0.920 g/cm³, b.p. 95-97° C.) containing 0.28 mol of hydrogen chloride/l of isopropenyl acetate are introduced into the tumbling autoclave via a pressure metering vessel, the mixture is heated to 110° C. and maintained at the reaction temperature for 2.5 hours while continuously distilling off the resulting acetone under pressure. After cooling to 80° C., the autoclave is vented, the liquid phase is drained and the acetylated beechwood boards are dried at 120° C. and a residence time of 4 hours in a drying tunnel.

The increase in weight of a cut-out test specimen which has been extracted with acetone in a Soxhlet apparatus for 4 hours and dried at 105° C. in a vacuum drying oven for 3 days is 16.1% by mass.

TABLE 1
Examples 1-13
Acetylation of wood powder with iso-propenyl
acetate in the liquid phase

| | HCl catalyst | | | Increase in weight |
|---|---|---|---|---|
| | mol/l of | Reaction | | as a result of |
| Ex. | isopr. | time | T | acetylation |
| No. | acetate | (hours) | (° C.) | (% by mass) |
| 0 | 0 | 3 | 85 | 0.1 |
| 1 | 0.112 | 3 | 85 | 3.1 |
| 2 | 0.16 | 3 | 85 | 8.3 |
| 3 | 0.216 | 3 | 85 | 13.4 |
| 4 | 0.32 | 3 | 85 | 15.8 |
| 5 | 0.32 | 0.5 | 85 | 9 |
| 6 | 0.32 | 1 | 85 | 10.8 |
| 7 | 0.35 | 1.5 | 85 | 14.3 |
| 8 | 0.32 | 6.0 | 85 | 19.2 |
| 9 | 0.32 | 3 | 50 | 4.1 |
| 10 | 0.32 | 3 | 60 | 8.2 |
| 11 | 0.32 | 3 | 75 | 14.4 |
| 12 | 0.32 | 3 | 85 | 15.8 |
| 13 | 0.32 | 3 | 95 | 16.1 |

TABLE 2
Examples 16-19
Acetylation of wood test specimens with isopropenyl
acetate in the liquid phase

| | HCl catalyst | | | Increase in weight |
|---|---|---|---|---|
| | mol/l of | Reaction | | as a result of |
| Ex. | isopr. | time | T | acetylation |
| No. | acetate | (hours) | (° C.) | (% by mass) |
| 0 | 0 | 3 | 85 | 0.1 |
| 16 | 0.32 | 3 | 85 | 23 |
| 17 | 0.32 | 6 | 85 | 23.9 |
| 18 | 0.32 | 1 | 85 | 17.3 |
| 19 | 0.32 | 2 | 85 | 22.7 |

1. A process for producing acetylated wood having an acetyl group content of from 3 to 30% by mass, based on dry wood, comprising the steps of reacting wood products having a residual moisture content of from 2 to 15% by mass at reaction temperatures of from 50 to 125° C. and residence times of from 0.2 to 6 hours with isopropenyl acetate in the presence of from 0.02 to 2% by mass, based on the isopropenyl acetate used, of acid catalysts, and then drying the wood products at temperatures of from 80 to 125° C./0.1 to 1 bar at residence times of from 0.2 to 8 hours, with the reaction with isopropenyl acetate being able to be carried out in the liquid phase or in the gas phase.

2. The process as claimed in claim 1, wherein the wood products used are solid wood products produced by material-removing machining, preferably in the form of veneers, boards, planks, squared timber, beams or profiles, wood particles, preferably in the form of wood flour, wood fibers or wood shavings, or wooden end products.

3. The process as claimed in claim 1, wherein the acid catalysts used are acids such as hydrogen chloride, phosphoric acid, boric acid, chlorosulfonic acid and/or p-toluene-sulfonic acid.

4. The process as claimed in claim 1, wherein the acid catalysts used are acid formers such as carboxylic anhydrides, preferably maleic anhydride, acetic anhydride, phthalic anhydride and/or pyromellitic dianhydride, carboxylic acid chlorides, preferably benzoyl chloride, acryloyl chloride and/or acetyl chloride, and/or chlorosilanes.

5. The process as claimed in claim 1, wherein the reaction with isopropenyl acetate is carried out in the liquid phase at a mass ratio of isopropenyl acetate/wood of from 0.5:1 to 15:1 and a reaction temperature of from 45 to 95° C.

6. The process as claimed in claim 5, wherein the reaction with isopropenyl acetate is carried out in the liquid phase at reaction temperatures of from 85 to 95° C., residence times of from 1.5 to 3 hours and using from 0.1 to 0.3 mol of concentrated hydrochloric acid as catalyst per liter of isopropenyl acetate used, with the acetone formed being distilled off during the reaction.

7. The process as claimed in claim 1, wherein the reaction of wood products with isopropenyl acetate is carried out in the gas phase at reaction temperatures of from 100 to 120° C. and residence times of from 0.3 to 3 hours under atmospheric pressure using gaseous isopropenyl acetate and hydrogen chloride gas.

8. The process as claimed in claim 1, wherein the reaction of wood products with isopropenyl acetate is carried out in autoclaves at reaction temperatures of from 90 to 120° C. and residence times of from 0.2 to 2 hours at from 1.1 to 35 bar using anhydrous hydrogen chloride as catalyst.

9. (canceled)
